(19) United States
(12) Patent Application Publication
(10) Pub. No.: US 2022/0230608 A1
(43) Pub. Date: Jul. 21, 2022

(54) Instant Music Composing Music Producing Software Application

(71) Applicants: Fred Jerkins, JR., Mays Landing, NJ (US); Ernes Manigo, JR., Nanuet, NY (US)

(72) Inventors: Fred Jerkins, JR., Mays Landing, NJ (US); Ernes Manigo, JR., Nanuet, NY (US)

(21) Appl. No.: 17/803,043

(22) Filed: Jan. 26, 2022

(51) Int. Cl. G10H 1/00

(52) U.S. Cl. CPC G10H 1/0025; G10H 2250/005; G10H 2210/111

(57) ABSTRACT

The Instant Music Composing Music Producing Software Application System will optimize the music writing, composing, producing and arranging experience by providing a convenient and thorough Instant Music Composing/Music Producing Software. This Automated Digital Producer and Composer is useful in the Music Production and Songwriting and Composing areas within the Music Industry; comparable to renown Digital Music Production Software such as ‘Fruity Loops”, Logic, Cubasic, and Protools.

The Instant Music Composing Music Producing Software Application provides a complete and convenient instant music maker, whereas the computations are unlimited combinations and sequences of its pre-stored database of loops, samples, music instrument sound, etc., that ultimately can create unlimited new songs.

### CROSS REFERENCE TO RELATED APPLICATION(S)

A) Reference to Claim Number 1
Title: Performance Data Processing Apparatus, Performance Data Processing Method, and Computer Readable Medium Containing Program for Implementing The Method
Inventors: Hiroki Nakazono, Hamamatsu (JP)
   Shigehiko Mizuno, Hamamatsu (JP)
Assignee: Yamaha Corporation, Hamamatsu-Shi (JP)
application Ser. No. 11/386,170
Filed: Mar. 21, 2006

| application Ser. No. | Filing date | U.S. Pat. No. | Issue Date |
|---|---|---|---|
| 11/386,170 | Mar. 21, 2006 | U.S. Pat. No. | Jun. 16, 2009 |
| | | 7,547,839 B2 | |

Related U.S. patent Documents to application Ser. No. 11/386,170

| U.S. Pat. No. | Issue Date | Inventor |
|---|---|---|
| U.S. Pat. No. 0,011,190 | January 2004 | Kawashima |

| Foreign Patents | |
|---|---|
| JP 61-255575 | November 1986 |
| JP 08-115084 | May 1996 |
| JP 142496 | May 2001 |
| JP 100120 | April 2002 |
| JP 039142 | February 2004 |

B) Reference to Claim Number 1
Title: Array of equipment For Composing
Inventors: Herbert Tuemandl, Vienna (AT)
Assignee: Vienna Symphonic Library GmbH, Vienna (AT)
application Ser. No. 10/275,259
Filed: May 9, 2001

| application Ser. No. | Filing date | U.S. Pat. No. | Issue Date |
|---|---|---|---|
| 10/275,259 | May 9, 2001 | U.S. Pat. No. | Sep. 12, 2006 |
| | | 7,105,734 B2 | |

Related U.S. patent Documents to application Ser. No. 10/275,259

| U.S. Pat. Nos. | Issue Date | Inventor |
|---|---|---|
| U.S. Pat. No. 5,142,961 | September 1992 | Paroutaud |
| U.S. Pat. No. 5,298,672 | March 1994 | Gallitzendorer |
| U.S. Pat. No. 5,357,048 | October 1994 | Sgroi |
| U.S. Pat. No. 5,693,902 | December 1997 | Hufford et. Al. |

| Foreign Patent | |
|---|---|
| EP 0237798 | September 1987 |

C) Reference to Claim Number 1
Title: Dynamically Changing Music
Inventors: Anton Perry Alferness, Seattle, Wash.
Assignee: Anton Alferness, Seattle, Wash.
application Ser. No. 10/435,417
Filed: May 9, 2003

| application Ser. No. | Filing date | U.S. Pat. No. | Issue Date |
|---|---|---|---|
| 10/435,417 | May 9, 2003 | U.S. Pat. No. | Jul. 18, 2006 |
| | | 7,078,607 B2 | |

Related U.S. patent Documents to application Ser. No. 10/435,417

| U.S. Pat. Nos. | Issue Date | Inventor |
|---|---|---|
| U.S. Pat. No. 5,693,902 | December 1997 | Hufford et. al. |
| U.S. Pat. No. 5,952,598 | September 1999 | Goede |
| U.S. Pat. No. 5,973,255 | October 1999 | Tanji |
| U.S. Pat. No. 6,093,880 | July 2000 | Arnalds |
| U.S. Pat. No. 6,281,420 | August 2001 | Suzuki et. al. |
| U.S. Pat. No. 6,281,421 | August 2001 | Kawaguchi |
| U.S. Pat. No. 6,433,266 | January 2002 | Fay et. al. |
| U.S. Pat. No. 6,683,241 | January 2004 | Wieder |
| U.S. Pat. No. 0,039,872 | November 2001 | Cliff |
| U.S. Pat. No. 0,159,566 | August 2003 | Safer et. al. |
| U.S. Pat. No. 0,112,202 | June 2004 | Smith et. al. |

D) Reference to Claim Number 1
Title: Systems and Methods For Creating, Modifying, Interacting with and laying Musical Compositions
Inventors: Alain George, Saint Paul de Vence (FR)
   Frederic Flohr, Le Val du Tignet (FR)
Assignee: MediaLab Solutions LLC (Chicago, Ill.)
application Ser. No. 10/324,581
Filed: Dec. 18, 2002

| application Ser. No. | Filing date | U.S. Pat. No. | Issue Date |
|---|---|---|---|
| 10/324,581 | Dec. 18, 2002 | U.S. Pat. No. | Dec. 20, 2005 |
| | | 6,977,335 B2 | |

Related U.S. patent Documents to application Ser. No. 10/324,581

| Pat. No. | Issue Date | Inventor |
|---|---|---|
| U.S. Pat. No. 4,399,731 | August 1983 | Aoki |
| U.S. Pat. No. 5,177,618 | January 1993 | Dunlap et. Al. |
| U.S. Pat. No. 5,300,723 | April 1994 | Ito |
| U.S. Pat. No. 5,307,456 | April 1994 | Mackay |
| U.S. Pat. No. 5,386,081 | January 1995 | Nakada et. al. |
| U.S. Pat. No. 5,496,962 | March 1996 | Meier et. al. |
| U.S. Pat. No. 5,523,525 | June 1996 | Murakami et. al. |
| U.S. Pat. No. 5,581,530 | December 1996 | Lizuka et. al. |
| U.S. Pat. No. 5,590,282 | December 1996 | Clynoo |
| U.S. Pat. No. 5,627,335 | May 1997 | Rigopulos et. al. |
| U.S. Pat. No. 5,640,590 | June 1997 | Luther |
| U.S. Pat. No. 5,648,628 | July 1997 | Ng et. al. |
| EP 0484047 | October 1991 | |
| EP 0702366 | September 1995 | |
| EP 0747877 | June 1996 | |
| EP 0857343 | October 1996 | |
| GB 230643 | April 1997 | |
| WO 05200 | July 1988 | |
| WO 02641 | March 1989 | |
| WO 15043 | April 1997 | |
| WO 35299 | September 1997 | |
| WO 33169 | July 1998 | |
| WO 01/63592 | August 2001 | |

E) Reference to Claim Number 1
Title: Method and Apparatus For Composing Original Musical Works
Inventors: Andy M. Milburn, New York, N.Y.
   Jay Hardesty, New York, N.Y.
   Joseph P. Lubin, New York, N.Y.
Assignee: Postmusic, LLC, New York, N.Y.
application Ser. No. 09/026,024
Filed: Feb. 19, 1998

| application Ser. No. | Filing date | U.S. Pat. No. | Issue Date |
|---|---|---|---|
| 09/026,024 | Feb. 19, 1998 | U.S. Pat. No. | Apr. 18, 2000 |
| | | 6,051,770 | |

Related U.S. patent Documents to application Ser. No. 09/026,024

| U.S. Pat. Nos. | Issue Date | Inventor |
|---|---|---|
| U.S. Pat. No. 4,926,737 | May 1990 | Minamitaka |
| U.S. Pat. No. 5,375,501 | December 1994 | Okuda |
| U.S. Pat. No. 5,486,646 | January 1996 | Yamashita et. al. |
| U.S. Pat. No. 5,548,080 | August 1996 | Minamitaka et. al. |
| U.S. Pat. No. 5,621,182 | April 1997 | Matsumoto |
| U.S. Pat. No. 5,627,335 | May 1997 | Rigopulos et. al. |
| U.S. Pat. No. 5,705,761 | January 1998 | Minamitaka |
| U.S. Pat. No. 5,736,666 | April 1998 | Goodman et. al. |
| U.S. Pat. No. 5,753,843 | May 1998 | Fay |
| U.S. Pat. No. 5,834,670 | November 1998 | Yumura et. al. |

| Foreign Patent | | |
|---|---|---|
| 0143578 | June 1985 | European Patent Office |

F) Reference to Claim Number 1
Title: Automatic Composer For Composing A Melody In Real Time
Inventors: Junichi Minamitaka, Oume, Japan
Assignee: Casio Computer Co. Ltd., Tokyo, Japan
U.S. Pat. No. 998,561
Filed: Dec. 29, 1992

| application Ser. No. | Filing date | U.S. Pat. No. | Issue Date |
|---|---|---|---|
| 998,561 | Dec. 29, 1992 | U.S. Pat. No. | Sep. 19, 1995 |
| | | 5,451,709 | |

Related U.S. patent Documents to U.S. Pat. No. 998,561

| U.S. Pat. Nos. | Issue Date | Inventor |
|---|---|---|
| U.S. Pat. No. 4,399,731 | August 1983 | Aoki |
| U.S. Pat. No. 4,664,010 | May 1987 | Sestero |
| U.S. Pat. No. 4,926,737 | May 1990 | Minamitaka |
| U.S. Pat. No. 4,982,643 | January 1991 | Minamitaka |
| U.S. Pat. No. 5,003,860 | April 1991 | Minamitaka |
| U.S. Pat. No. 5,088,380 | February 1992 | Minamitaka |
| U.S. Pat. No. 5,099,740 | March 1992 | Minamitaka |
| U.S. Pat. No. 5,218,153 | June 1993 | Minamitaka |

| Foreign Patent | | |
|---|---|---|
| 62-187876 | August 1987 | Japan |
| WO 05616 | September 1986 | WIPO |

G) Reference to Claim Number 2
Title: RedBook Audio Sequencing
Inventors: Matthew W. Smith, Tulsa, Okla.
Assignee: Microsoft Corporation, Redmond, Wash.
U.S. Pat. No. 510,260
Filed: Aug. 2, 1995

| application Ser. No. | Filing date | U.S. Pat. No. | Issue Date |
|---|---|---|---|
| 510,260 | Aug. 2, 1995 | U.S. Pat. No. | Dec. 23, 1997 |
| | | 5,701,511 | |

Related U.S. patent Documents to U.S. Pat. No. 510,260

| U.S. Pat. Nos. | Issue Date | Inventor |
|---|---|---|
| U.S. Pat. No. 5,440,677 | August 1995 | Case et. al. |
| U.S. Pat. No. 5,471,576 | November 1995 | Yee |
| U.S. Pat. No. 5,515,490 | May 1996 | Buchanan et. Al |
| U.S. Pat. No. 5,542,023 | July 1996 | Sakai et. al. |

H) Reference to Claim Number 2
Title: Man/Machine Interface
Inventors: Guy S. Huffener, Krelttmayr Str 28, D-8000 Munchen 2, Germany
Assignee:
U.S. Pat. No. 910,253
Filed: Nov. 13, 1990

| application Ser. No. | Filing date | U.S. Pat. No. | Issue Date |
|---|---|---|---|
| 910,253 | Nov. 13, 1990 | U.S. Pat. No. | Jan. 17, 1995 |
| | | 5,382,891 | |

Related U.S. patent Documents to U.S. Pat. No. 910,253

| U.S. Pat. Nos. | Issue Date | Inventor |
|---|---|---|
| U.S. Pat. No. 4,692,676 | September 1987 | Dohi et. al. |
| U.S. Pat. No. 4,732,099 | March 1988 | Neki et. al. |
| U.S. Pat. No. 4,749,923 | June 1988 | Chieng. |
| U.S. Pat. No. 5,180,954 | January 1993 | Wekana et. al. |
| U.S. Pat. No. 5,189,968 | March 1993 | Eichenseer |

I) Reference to Claim Number 3
Title: System and Method For Enabling Multimedia Production Collaboration Over a Network
Inventors: Matthew D. Moller, San Francisco, Calif.
Graham Lyus, Bexley (GB)
Michael Franke, San Francisco, Calif.
Assignee: Rocket Network, Inc., San Francisco, Calif.
application Ser. No. 09/401,318
Filed: Sep. 23, 1999

| application Ser. No. | Filing date | U.S. Pat. No. | Issue Date |
|---|---|---|---|
| 09/401,318 | Sep. 23, 1999 | U.S. Pat. No. | Jul. 23, 2003 |
| | | 6,598,074 B1 | |

Related U.S. patent Documents to application Ser. No. 09/401,318

| Pat. No. | Issue Date | Inventor |
|---|---|---|
| U.S. Pat. No. 5,617,539 | August 1983 | Ludwig et. al. |
| U.S. Pat. No. 5,805,821 | January 1993 | Saxena et. al. |
| U.S. Pat. No. 5,811,706 | April 1994 | Van Buskirk et. al. |
| U.S. Pat. No. 5,880,788 | August 1983 | Bregler |
| U.S. Pat. No. 5,886,274 | August 1983 | Jungleib |
| U.S. Pat. No. 5,926,205 | August 1983 | Krause et. al. |
| U.S. Pat. No. 5,952,599 | August 1983 | Dolby et. al. |
| U.S. Pat. No. 5,995,491 | August 1983 | Richter et. al. |
| U.S. Pat. No. 6,014,694 | August 1983 | Aharoni et. al. |
| U.S. Pat. No. 6,061,717 | August 1983 | Carleton et. al. |
| U.S. Pat. No. 6,105,055 | August 1983 | Pizano et. al. |
| U.S. Pat. No. 6,154,600 | August 1983 | Newman et. al. |
| U.S. Pat. No. 6,243,676 | August 1983 | Witterman |
| U.S. Pat. No. 6,269,394 | August 1983 | Kenner et. al. |
| U.S. Pat. No. 6,295,058 | August 1983 | Hsu et. al. |
| U.S. Pat. No. 6,320,600 | August 1983 | Smith et. al. |
| U.S. Pat. No. 6,351,471 | August 1983 | Robinett et. al. |
| U.S. Pat. No. 6,438,611 | August 1983 | Hara et. al. |
| EP 0933906 | April 1999 | |
| WO 9,411,358 | May 1994 | |

J) Reference to Claim Number 3
Title: Computer Based Automatic Audio Mixer
Inventors: John D. Marshall, Redwood City, Calif.
   John C. Gaddy, Cupertino, Calif.
Assignee: John C. Gaddy, Cupertino, Calif.
application Ser. No. 09/751,151
Filed: Dec. 27, 2000

| application Ser. No. | Filing date | U.S. Pat. No. | Issue Date |
|---|---|---|---|
| 09/751,151 | Dec. 27, 2000 | U.S. Pat. No. | Apr. 28, 2009 |
| | | 7,526,348 B1 | |

Related U.S. patent Documents to application Ser. No. 09/751,151

| U.S. Pat. Nos. | Issue Date | Inventor |
|---|---|---|
| U.S. Pat. No. 2,265,097 | December 1941 | Best |
| U.S. Pat. No. 5,341,253 | August 1994 | Liao et. al. |
| U.S. Pat. No. 5,608,707 | March 1997 | Ogawa |
| U.S. Pat. No. 5,621,805 | April 1997 | Loh et. al. |
| U.S. Pat. No. 5,768,126 | June 1998 | Frederick |
| U.S. Pat. No. 5,774,567 | June 1998 | Heyl |
| U.S. Pat. No. 5,859,826 | January 1999 | Ueno et. al. |
| U.S. Pat. No. 5,978,762 | November 1999 | Smyth et. al. |
| U.S. Pat. No. 6,636,609 | October 2003 | Ha et. al. |

### STATEMENT REGARDING FEDERALLY SPONSORED RESEARCH OR DEVELOPMENT

Not Applicable

### REFERENCE TO SEQUENCE LISTING A TABLE A COMPUTER PROGRAM LISTING COMPACT DISC APPENDIX

Applicable Software Program

### BACKGROUND OF THE INVENTION

### a) Field of Invention

This Instant Music Composing/Music Producing Software and Algorithm referred to as “iTDO Digital Music System—The Automated Digital Producer and Composer” is useful in the Music Production and Songwriting and Composing areas within the Music Industry; comparable to Digital Music Production Software such as ‘Fruity Loops”, Logic, Cubasic, and Protools.

### b) Classification Definition

According to the U.S. Patent Classification System—Classification Definitions, for this “iTDO Digital Music System—The Automated Digital Producer and Composer” is Class 84/609. Class Definition for 84/609 is MUSIC/NOTE SEQUENCE (also 408 should be acknowledge as a subclass); Also Class 700/67/94 DATA PROCESSING: GENERIC CONTROL SYSTEMS OR SPECIFIC APPLICATION/DIGITAL AUDIO DATA PROCESSING SYSTEM (also 381 should be acknowledge as a subclass)

Theses class definitions above herein provides for utility patents claiming Music Utility Software and Algorithm as a succession of musical notes is sequentially processed by digital memory circuit for performance or comparison. This subclass 67 refers to plural sensed conditions or plural signals developed from a single sensed condition are utilized to generate a control system signal. And Subclass 94 whereas the particular art or field is the processing of digital data which represents an audio signal.
(1) Note. This subclass is limited solely to audio data processing systems that are not classified elsewhere.
(2) Note. An “audio signal” is an electrical signal which represents spoken or other sounds which vary with time, and may be in digital or analog form (this form implies a conversion to digital form before the digital data processing).
(3) Note. Nominal recitation of “audio” is not sufficient to afford classification herein of an invention which would be otherwise classified elsewhere.

Lastly, subclass 381 covers Electrical Audio Signal Processing Systems and Devices, appropriate subclasses.

### c) Description of Prior Model

The industry has done well with Digital Music Production Software such as ‘Fruity Loops”, Logic, Cubasic, and Protools. These programs are used to arrange, compose, and produce songs. These programs also have database capabilities to store sounds and “loops” samples to help a non-musician producer create music compositions using whats already pre-recorded in the software. However, never has there been an extra added convenience of having a computer which can create melodies, select arrangements, and structure sequences to create new songs to an infinite degree like the “iTDO Digital Music System—The Automated Digital Producer and Composer”. Music Producers and Songwriters sometimes suffer from writers block and cannot always come up with fresh new ideas, or, music producers and songwriters may become too busy to produce all the songs their obligated to create and arrange. The iTDO Digital Music System—The Automated Digital Producer and Composer can create songs to an infinite degree from its pre-stored database of loops, samples, musical instrument sound, etc., that ultimately can create unlimited new songs. Uniquely, Producers and Songwriters can upload their own loops and sounds, etc. into the computer and iTDO Digital Music System's permutation and combination software algorithm will be able to sequence unlimited songs with their sound. Also, anyone who needs to complete a music project but do not know how to produce can purchase the iTDO Digital Music System—The Automated Digital Producer and Composer software and have it create songs from its generic pre-stored database of loops, samples, music instrument sound, etc., that ultimately can create unlimited new songs. If they want deluxe editions which will have a digital blueprint of the special sounds and pre-programmed melody patterns and production styles from renowned star producers, however the software will cost more. Lastly, if anyone desires to sing on any of the new tracks created by the iTDO Digital Music System—The Automated Digital Producer and Composer software, the software also has a component whereas if a non-singer simply records their own voice singing a song, the software will be able to apply a melody (which will be generated by the software) to the recorded voice, quantize the timing and correct the notes, pitch and tonality.

### BRIEF SUMMARY OF INVENTION

The “iTDO Digital Music System—The Automated Digital Producer and Composer” provides a complete and convenient instant music maker, whereas the computations are unlimited combinations and sequences of its pre-stored database of loops, samples, music instrument sound, etc., that ultimately can create unlimited new songs.

### The Following Pages are Drawings: Pages 11A Through 11L

The following diagrams show the algorithm computational flow and combination options with is encoded within the software of the iTDO Digital Music System solution.

In all drawings and diagrams, BLACK represents Music Genre, ORANGE represents Music Structure and Style, GREEN represents Musical Beat, PURPLE represents Musical Melody and Rhythm, and BLUE represents the Music Format and Arrangement.

In FIG. 1 on Page 11a shows a summarized breakdown of each music ingredient from Structure, Beat, Melody & Rhythm and Format Arrangement.

In FIG. 2 on Page 11b it shows Music Genre 1 (as indicated with a Black Rectangle with the number 1 in it), whereas the arrows flow in the sequence which the algorithm will follow in computing a Rhythm & Blues/Hip Hop Composition.

In FIG. 3 on Page 11c, the Legend decodes the symbols and color codes of the Diagram “FIG. 1” on Page 11b.

In FIG. 4 on Page 11d it shows Music Genre 2 (as indicated with a Black Rectangle with the number 2 in it), whereas the arrows flow in the sequence which the algorithm will follow in computing a Pop Music Genre Composition.

In FIG. 5 on Page 11e, the Legend decodes the symbols and color codes of the Diagram “FIG. 3” on Page 11d.

In FIG. 6 on Page 11f it shows Music Genre 1 (as indicated with a Black Rectangle with the number 1 in it), whereas the arrows flow in the sequence which the algorithm will follow in computing a Gospel Music Genre Composition.

In FIG. 7 on Page 11g, the Legend decodes the symbols and color codes of the Diagram “FIG. 5” on Page 11f.

In FIG. 8 on Page 11 h it shows Music Genre 1 (as indicated with a Black Rectangle with the number 1 in it), whereas the arrows flow in the sequence which the algorithm will follow in computing a Country Music Genre Composition.

In FIG. 9 on Page 11i, the Legend decodes the symbols and color codes of the Diagram “FIG. 7” on Page 11h.

In FIG. 10 on Page 11j it shows Music Genre 1 (as indicated with a Black Rectangle with the number 1 in it), whereas the arrows flow in the sequence which the algorithm will follow in computing a Rock and/or Alternative Music Genre Composition.

In FIG. 11 on Page 11k, the Legend decodes the symbols and color codes of the Diagram “FIG. 9” on Page 11j.

FIGS. 12a and 12b on Page 11l and 11m, consecutively, shows the entire algorithm flow diagram from start to finished composition using the same applicable symbols and color codes associated with consistently coded Legends FIG. 3, FIG. 5, FIG. 7, FIG. 9, and FIG. 11.

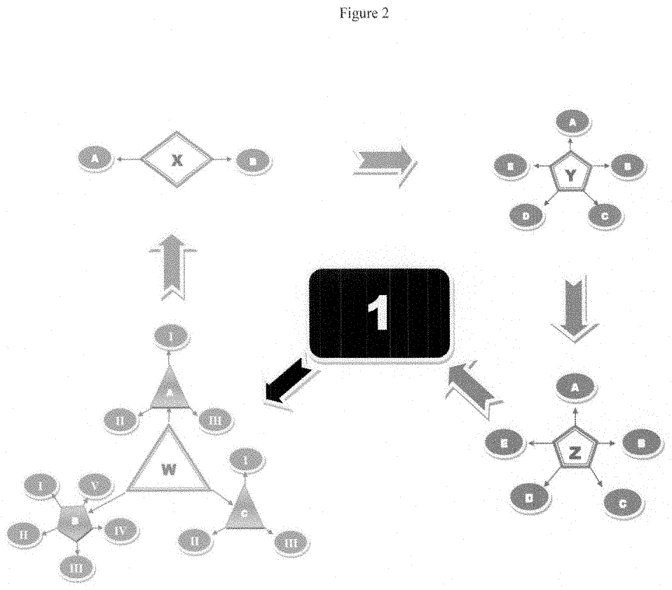

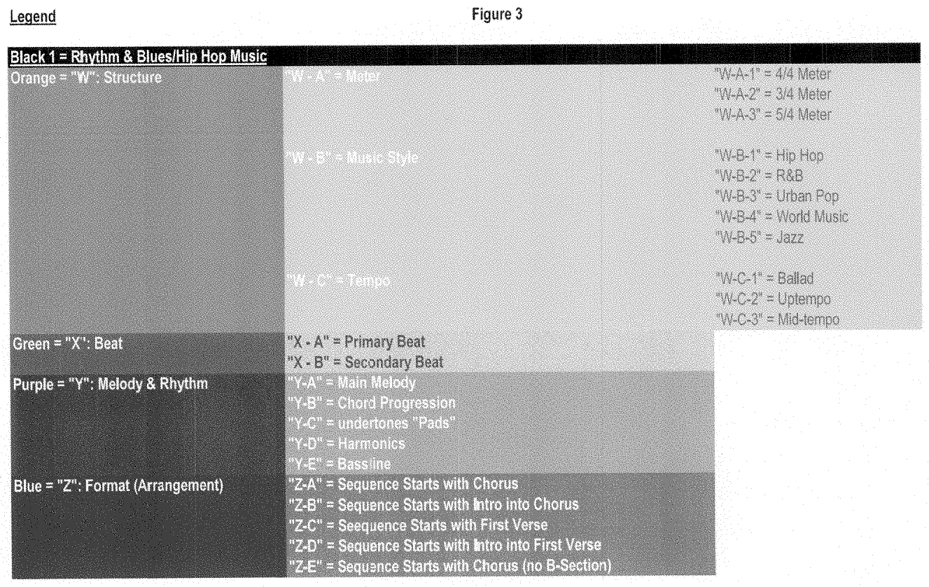

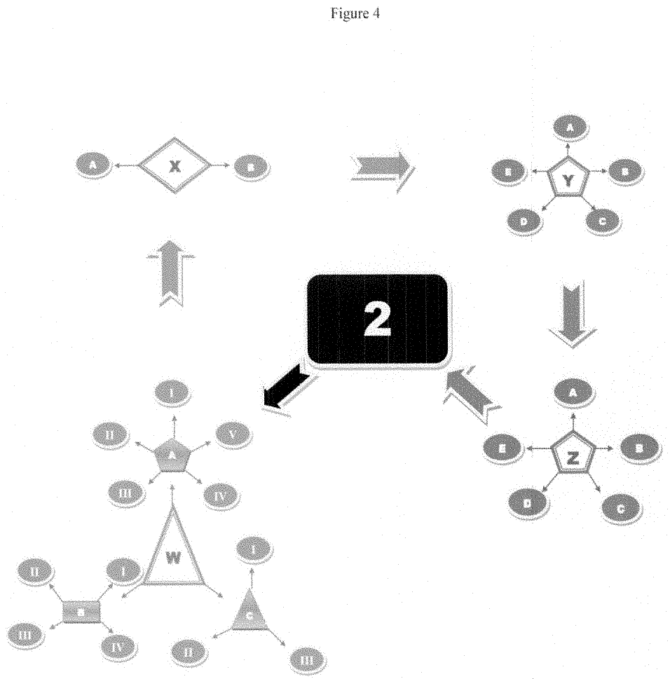

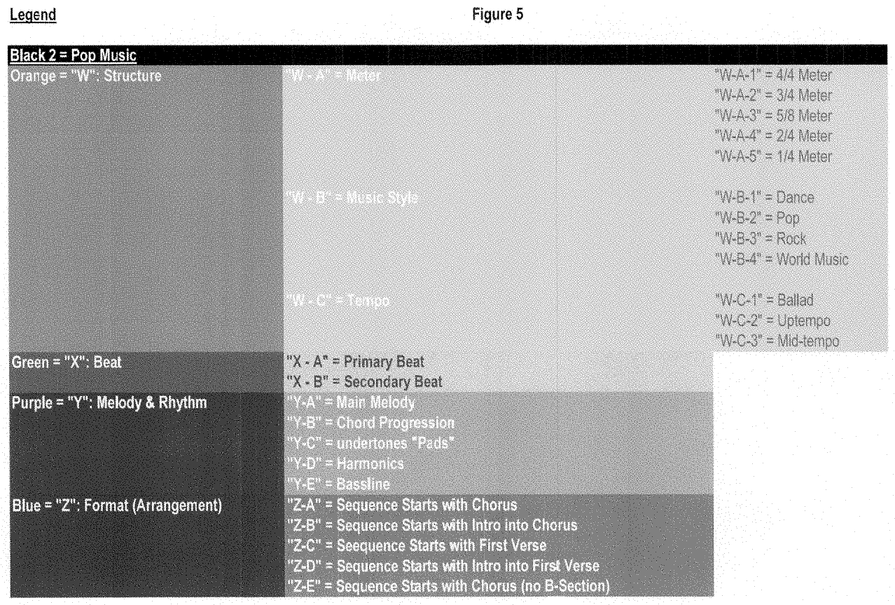

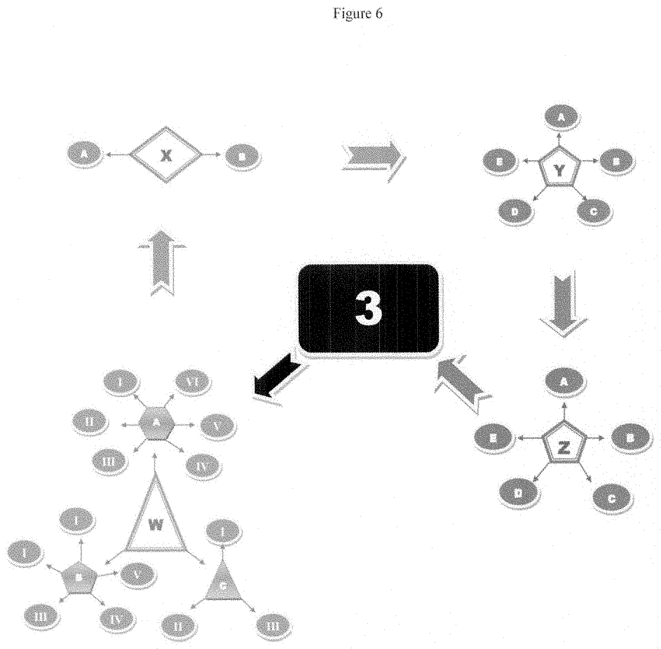

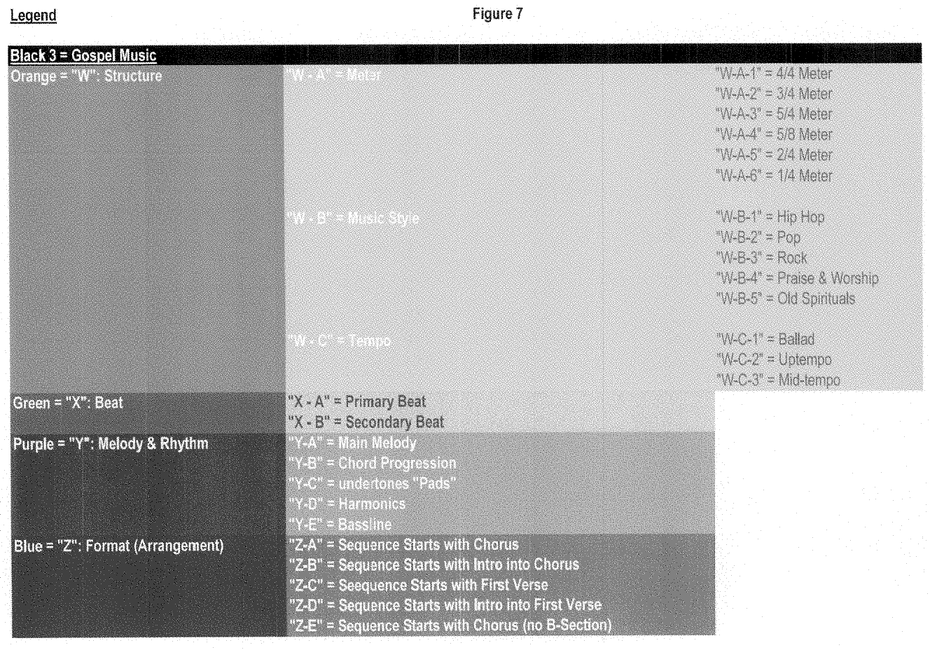

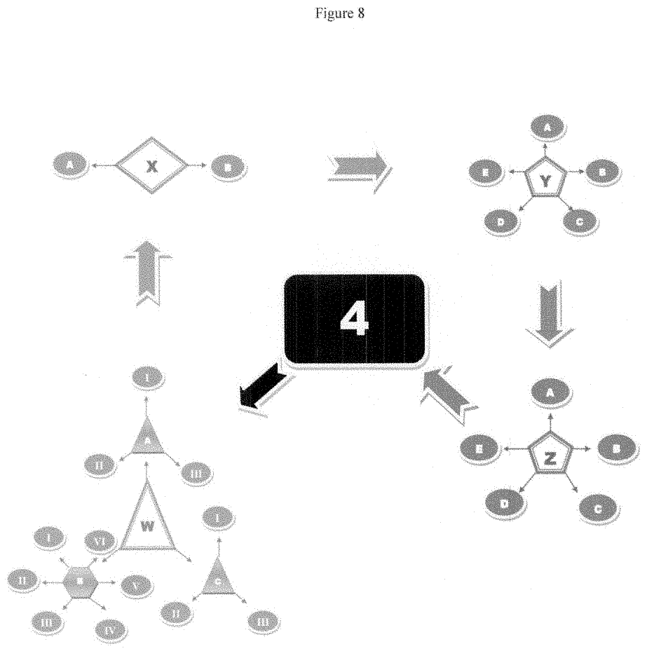

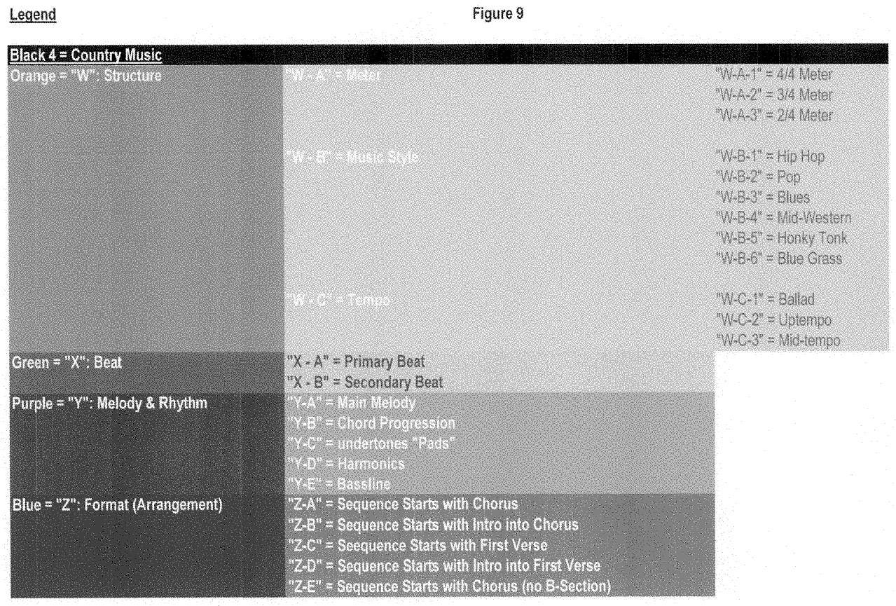

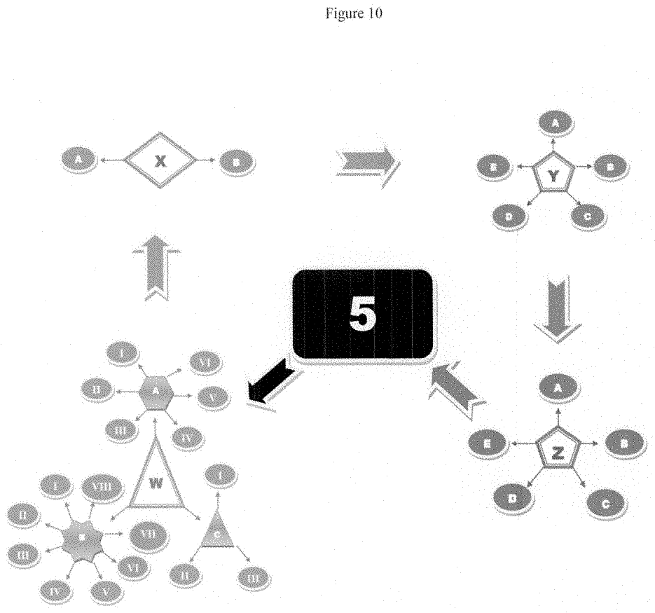

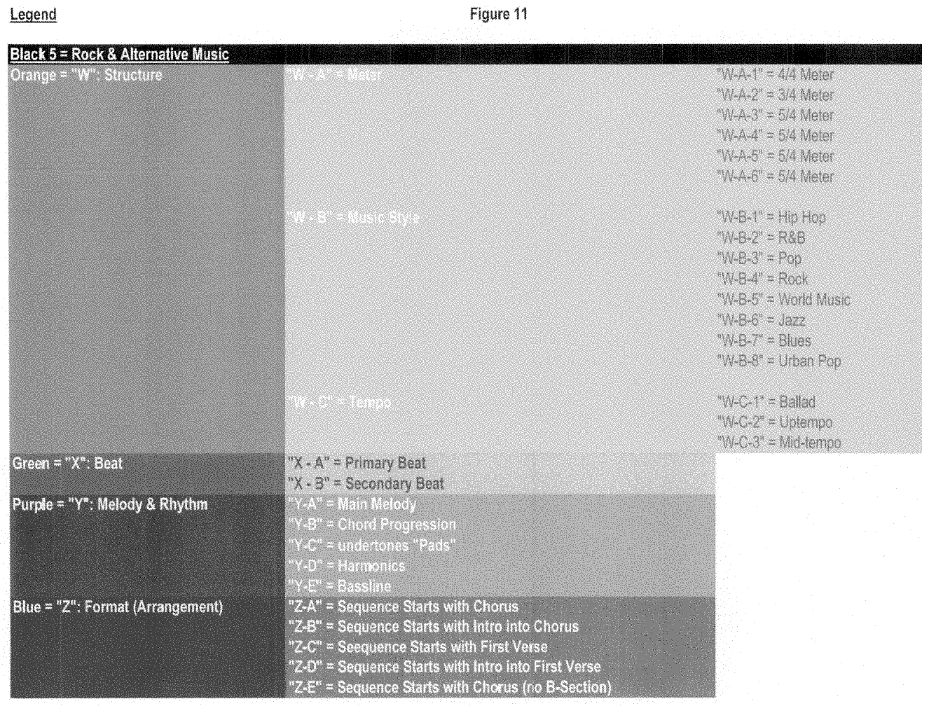

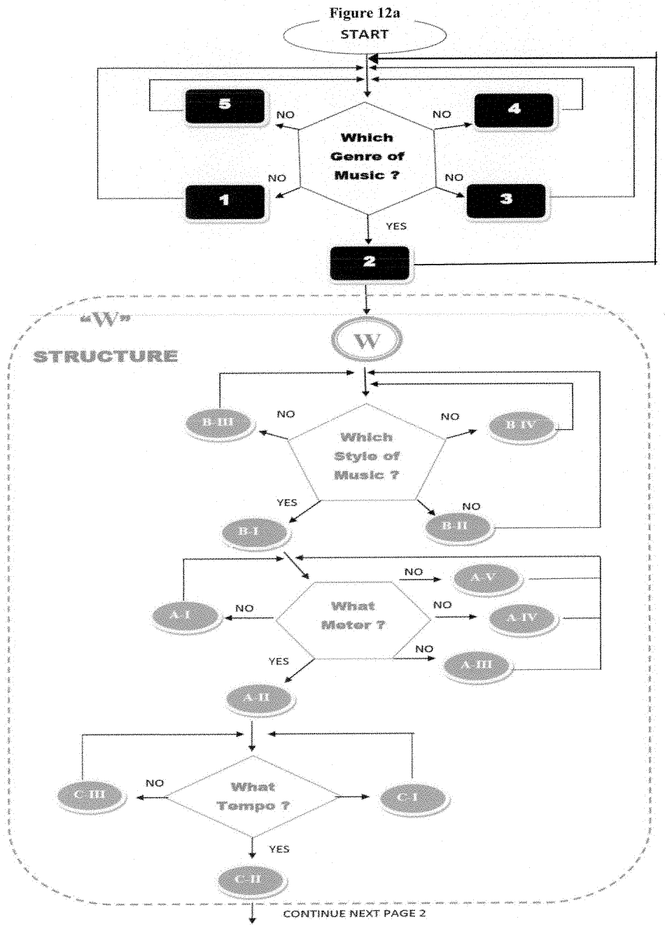

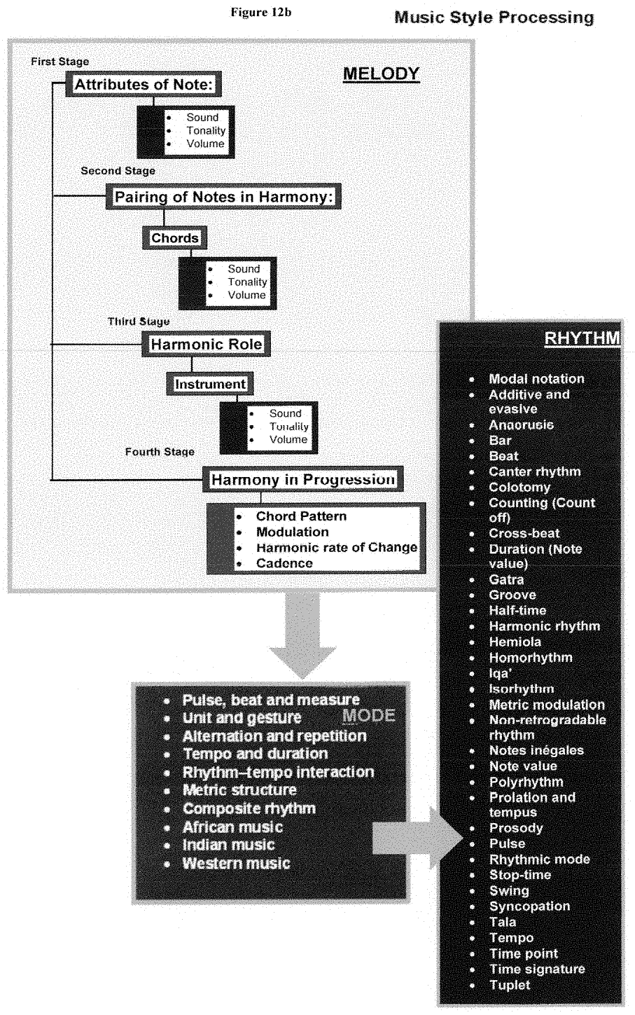

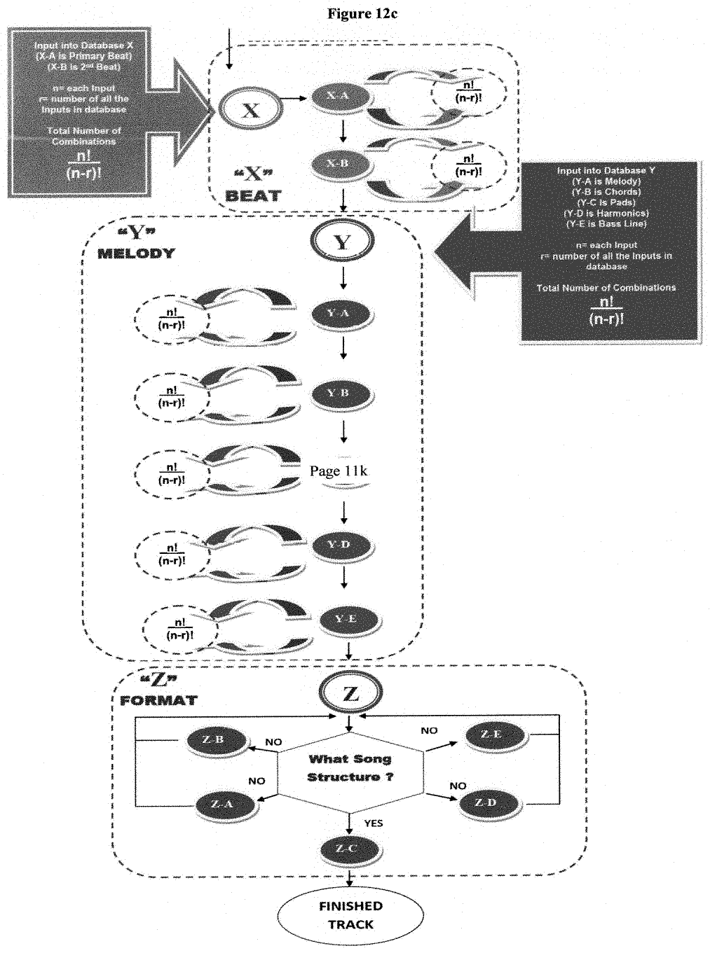

### DETAIL DESCRIPTION OF THE INVENTION

Introduction: “iTDO Digital Music System—The Automated Digital Producer and Composer”

Clarifications
Music Producers and Songwriters sometimes suffer from writers block and cannot always come up with fresh new ideas, or, music producers and songwriters may become too busy to produce all the songs their obligated to create. The iTDO Digital Music System—The Automated Digital Producer and Composer can create songs of any genre of music globally from its pre-stored database of loops, samples, music instrument sound, etc., that ultimately can create unlimited new songs. Uniquely, Producers and Songwriters can also upload their own loops and sounds, etc. into the computer and iTDO Digital Music System's permutation and combination software algorithm will be able to sequence unlimited songs with their sound.
Anyone who needs to complete a music project but do not know how to produce can purchase the iTDO Digital Music System—The Automated Digital Producer and Composer software and have it create songs from its generic pre-stored database of loops, samples, music instrument sound, etc., that ultimately can create unlimited new songs. If they want deluxe editions which will special sounds from star producers, however the software will cost more.
Every new composition will be associated with a digital computer generated “blueprint” of itself which will be stored and filed into a database so it can instantly be referenced and found when necessary. The necessity to reference and find the “blueprint” of the composition is so that if the software utility creates a sequence and composition that was already created, produced and composed, the iTDO Digital Music System system will alert the user, prohibit the user from saving the sequence and composition, and request user to try again. The iTDO Digital Music System system will require user to register software online, and, register each composition created online on the iTDO Digital Music System website utility. Every composition and sequence written and produced by the iTDO Digital Music System software is owned and is the property of iTDO Digital Music System creators and owners. If a producer(s) later alter, add to, re-arrange or change the musical composition that was originally created using the iTDO Digital Music System Solution, the resulting composition will still be the copyrighted property of the iTDO Digital Music System owner and creators.
Anyone who desires to sing on any of the new tracks created by the iTDO Digital Music System—The Automated Digital Producer and Composer software, the software also has a component whereas if a non-singer simply records their own voice singing a song, the software will be able to apply a melody (which will be generated by the software) to the recorded voice, quantize the timing and correct the notes, pitch and tonality.

Identifies and Defines Purpose
The purpose of “iTDO Digital Music System—The Automated Digital Producer and Composer” is to provide extra added convenience, higher volume of song output, and reliable quality by having the computer select arrangements and sequences to create new songs.

The “iTDO Digital Music System—The Automated Digital Producer and Composer” software is based on the algorithm designed and formulated to manipulate various pre-recorded and digitized sounds and musical loops compiled and stored in a database so it can be randomly selected and structured into a song format.

iTDO Digital Music System—The Automated Digital Producer and Composer uploads musical loops and sounds into a database and categorized; each input automatically goes into either a database of musical “loops”, all sounds goes into a “sound bank” which allows the software access to the sound when it is about to chose a sound, and form a music melody with the sound, as well as into a database which categorizes by instruments. This would be accomplished when the software is placed in “Upload Mode”.

iTDO Digital Music System—The Automated Digital Producer and Composer selects pre-recorded sounds and loops, and combined them and arrange them into songs. For example: the software will knows the time signature, pitch, tempo, tone, and key of any pre-recorded sound or loop, so, it can match these elements to prevent sonic incompatibility, and to assure perfect musical blends. The software also knows various song structures and formats; therefore it can isolate and arrange section of loops and sounds and properly place them into a song arrangement and format. This would be accomplished when the software is placed in “song mode”.

We claim:

1. “iTDO Digital Music System” provides a New Method and System for Composing Original Musical Works. This Instant Music Composing/Music Producing Software and Algorithm referred to as “iTDO Digital Music System—The Automated Digital Producer and Composer” is useful in the Music Production and Songwriting and Composing areas within the Music Industry.

2. The “iTDO Digital Music System” is a Music Composing/Music Producing Software and Algorithm referred to as “iTDO Digital Music System—The Automated Digital Producer and Composer”.

3. The “iTDO Digital Music System” has a Unique Automated Music Digital Producer and Composer software solution which will enable blueprinting digital copies of compositions, referencing and filing compositions, comparing files for duplication instantly, and user interfacing and communication with software, composer, and owner's system database.
